(19) United States
(12) Patent Application Publication
(10) Pub. No.: US 2009/0317525 A1
(43) Pub. Date: Dec. 24, 2009

(54) PROCESS FOR PREPARATION OF SAFFRON CREAM LIQUEUR

(75) Inventor: Arun Dhandhania, Rajasthan State (IN)

Correspondence Address: SUGHRUE MION, PLLC, 2100 PENNSYLVANIA AVENUE, N.W., SUITE 800, WASHINGTON, DC, 20037, US

(73) Assignee: Ratnesh Enterprise Pvt. Ltd., Jaipur, Rajasthan State (IN)

(21) Appl. No.: 12/440,838

(22) PCT Filed: Nov. 22, 2006
(86) PCT No.: PCT/IN06/00467

§ 371 Date: Mar. 11, 2009

(30) Foreign Application Priority Data
Sep. 26, 2006 (IN) 2128/DEL/2006

(51) Int. Cl. C12G 3/06

(52) U.S. Cl. 426/386; 426/592

(57) ABSTRACT

The process for the preparation of Saffron Cream Liqueur comprising:—preparing saffron concentrate by adding saffron 1-5 gm. in one liter of ENA (extra neutral alcohol) of 68% OP, i.e., 96% v/v,—intermittently stirring the said mixture of ENA and saffron for 18-36 hours, extracting the essential oil containing aroma, color and flavor,—filtering the said mixture of saffron and the ENA to obtain the saffron concentrate, diluting the said concentrate from 68% OP to −9-45% by adding demineralized water at room temperature, adding about 5-15% food grade white milk cream and properly mixing it, adding about 5-20% food grade sugar and mix till sugar is dissolved,—adding about 1-5% food grade flavoring agent and mixing it thoroughly and filtering to get saffron cream liqueur.

### FIELD OF INVENTION

The present invention relates to the process for the preparation of Saffron Cream Liqueur.

### BACKGROUND OF INVENTION

Liqueur is a sweet alcoholic beverage, often flavoured with fruits, herbs, spices, flowers, seeds, roots, plants, barks, and sometimes cream. The word liqueur comes from the Latin word liquifacere, which means, “to dissolve.” This refers to the dissolving of the flavourings used to make the liqueur.

In some parts of the world people use the words cordial and liqueur interchangeably. Though in these places the two expressions both describe liquors made by redistilling spirits with aromatic flavorings and are usually highly sweetened, there are some differences. While liqueurs are usually flavored with herbs, cordials are generally prepared with fruit pulp or juices. Nearly all liqueurs are quite sweet, with a highly concentrated, dessert-like flavour.

Today liqueurs are made worldwide and can be enjoyed many different ways, including by themselves, poured over ice, with coffee, and mixed with cream or other mixers to create cocktails.

There are many categories of liqueurs including: fruit liqueur, cream liqueur, coffee liqueur, chocolate liqueur, schnapps liqueur, brandy liqueur, anise liqueur, nut flavoured liqueur, and herbal liqueur.

The general principle of liqueur making is to take an alcohol base (sometimes called “neutral spirits”) and steep a flavoring in it for a time. Next, filter out any remaining solids, add sweetening, and age. Finally, bottle and serve. Those steps are the simple skeleton structure of making a liqueur, but it's the details (just what flavoring; just how long; just what sweetener), and the variations, that make up the soul of your product. Every recipe is different, and many have somewhat different procedures, but they each pretty much come down to that. And each flavor creates its own dynamics over time, so it may take a while to learn how it all goes together.

U.S. Pat. No. 4,957,765 disclose a system and method for preparing cream liqueur products having improved emulsion stability and products thereof. The method comprises the steps of preparing a spirits premix by combining spirits, a carbohydrate, and water, and preferably including flavoring and colorant; preparing a protein premix by dissolving citric acid or a salt thereof and caseinate in water; thoroughly mixing the protein premix with cream, preferably double cream; thereafter preparing a product mixture by mixing the spirit premix with the mixture of cream and the protein premix; and homogenizing the product mixture so that the average particle size is reduced to less than 5 microns, preferably less than 2 microns.

EP patent 0067592 discloses a liqueur is disclosed which contains fresh cream yet remains stable against separation despite an alcohol content of from about 5 to about 25%. The cream base and spirit portions were prepared and combined to form a stable product having a pH above about 6.3. The cream base portion was prepared from cream, sugar, an antioxidant, an emulsifier having a hydrophilic/lipophilic balance of less than about 12, a soluble casein salt as an emulsion stabilizer, and flavoring and/or color if desired. The cream base portion was homogenized prior to blending or the blend of the cream base and spirit portions was homogenized, to form a stable emulsion wherein the fat globules were reduced in size such that at least 95% are less than 1 micron in diameter, and substantially none are greater than 8 microns in diameter. The spirit portion was flavored and/or colored as desired.

UA0070479 teaches a cream-liqueur “Stepova Krasunia”. Cream-liqueur contains rectified ethyl alcohol of the highest purity, sugar, aromatizer and water. Additionally it contains dry extract of chicory and dry non-fat milk at a ratio of 1:2 as recalculated per dry substance and fresh egg yolks.

UA0068134 discloses a cream-liqueur containing rectified ethyl alcohol of the highest purity, sugar, emulsifier, aromatizer and water. Additionally the cream—liqueur contained cicorlact (dry extract of chicory and dry skimmed milk at a ratio of 1:2 on the dry substance basis). As emulsifier soya phytolecithin had been used.

IE0950243 talks about the process for the preparation of a cream liqueur beverage product. The process for the preparation of a cream liquer beverage product having a narrow alcohol range, which process comprises carrying out all steps, post-addition of alcohol, in a closed system.

CA2219829, CN1219582 and TW0386110 teaches a process for manufacture of saffron liqueur beverage. The flavouring agent containing saffron available in nature and capable of stenghthing the flavour of liqueur comprising the steps of soaking the 450 gms of Saffron in the admixture of silent spirit of 27% strength and the balance demineralized water for 8 hrs at room temperature, for the essential ingredients of saffron to dissolve in the alcoholic solution which should be intermittently stirred for proper mixing the essential ingredients in the said alcoholic solution. To increase the aroma and colour, the quantity of Saffron is increased or decreased as per taste. The mixture was then heated at 78° C. and then distilled at 80° C. in a special distilling apparatus condensing the decoction of saffron liqueur having strength of 9% to 54%, which cooled at the condenser at room temperature for 24 hours, and then kept in freezer. If required, 100 gms of sugar refined fine white or equivalent of sugar syrup may be added to and mixed properly with the mixture 1 bulk liter of admixture. It may also be added to demineralised water in such quantities that the blended Extra Neutral Alcohol contents from 90 mg.

EP0875561 teaches a process for preparing saffron flavored beverage in particular liqueur. The process is characterized in that it comprises the preparation of a flavouring agent containing saffron available in nature and capable of strengthening the flavour of liqueur. comprising the steps of: cleaning the saffron, grinding and/or converting it into saffron syrup distilled at 80° C. in a special distilling apparatus, condensing the decoction of saffron liqueur having a strength of 5% to 51%, then cooling and adding this decoction to demineralised water in such quantities that the blended Extra Neutral Alcohol contents from 90 mg to 270 mg decoction of saffron based on the weight of the blended Extra Neutral Alcohol per bulk litre of the finally obtained beverage. The invention can be used in the manufacture of beverages, which are flavoured with saffron.

None of the prior art document talks about a saffron flavoured alcoholic cream beverage. Several cream based liqueurs are known in the art however none of the said cream liqueur is flavoured with saffron.

There are only 2 known processes to produce the alcoholic beverages, one is ‘hot’ process & the other one is ‘cold’ process. The ‘hot’ process is being followed in producing the ‘Saffron Liqueur’. The hot process takes less time than cold process. But it is more expensive than cold process. It requires bigger space than the cold process. It requires more investment in plant & equipments than the cold process.

The object of the invention is to propose a process for the preparation of saffron cream liqueur by cold process to obviate the disadvantages of hot process.

### SUMMARY OF INVENTION

The present invention relates to the process for the preparation of saffron cream liqueur comprising the steps of:
preparing saffron concentrate by adding saffron 1-5 gm in one liter of ENA (extra neutral alcohol) of 68% OP, i.e., 96% v/v,
intermittently stirring the said mixture of ENA and saffron for 18-36 hours,
extracting the essential oil containing aroma, color and flavor,
filtering the said mixture of saffron and the ENA to obtain the saffron concentrate,
diluting the said concentrate from 68% OP to 9-45% by adding demineralized water at room temperature,
adding about 5-15% food grade white milk cream and properly mixing it,
adding about 5-20% food grade sugar and mix till sugar is dissolved,
adding about 1-5% food grade flavoring agent and mixing it thoroughly and filtering to get saffron cream liqueur.

The flavouring agents used in the instant invention are natural flavouring agents. More particularly the flavouring agent is saffron.

The saffron cream liqueur of the present invention is stored in clean jar made of either of glass or steel at 15° C.

### DETAILED DESCRIPTION OF THE INVENTION

The present invention relates to the process of preparation of the saffron cream liqueur. The process in the present invention followed in producing the saffron cream liqueur is the ‘cold’ process.

The ‘hot’ process is being followed in producing the saffron liqueur, whereas the ‘cold’ process is being followed in producing the saffron cream liqueur. The cold process does not involve the heating of the ingredients for the preparation of the liqueur. The hot process takes lesser time than cold process. But it is more expensive than cold process. It requires bigger space than the cold process. It requires more investment in plant & equipments than the cold process. However, both the process achieves the same result. No difference in result at all.

The process of the present invention comprises the steps of preparing saffron concentrate by adding saffron 1-5 gm in one liter of ENA (extra neutral alcohol) of 68% OP, i.e., 96% v/v, intermittently stirring the said mixture of ENA and saffron for 18-36 hours, extracting the essential oil containing aroma, color and flavor, filtering the said mixture of saffron and the ENA to obtain the saffron concentrate, diluting the said concentrate from 68% OP to 9-45% by adding demineralized water at room temperature, adding about 5-15% food grade white milk cream and properly mixing it, adding about 5-20% food grade sugar and mix till sugar is dissolved, adding about 1-5% food grade flavoring agent and mixing it thoroughly and filtering to get saffron cream liqueur. Admix of ENA & DMW is prepared of the required strength, i.e., say 18%. Approximately the temperature of admix rises 4 to 5° C. above the room temperature when ENA & DMW are mixed together. It is required to be left the admix until the temperature comes down back to room temperature.

Then required quantity of ‘saffron’ is added and kept the same for 24 to 36 hours with intermittent stirring until all the ‘essential oil’ i.e., aroma colour & flavour, is thoroughly dissolved in the admix of ENA & DMW of 18% strength.

Then white cream of around 10% and white choclet of around 1% are mixed in it. It should be mixed properly for around 12 hours with intermitting stirring until is fully mixed in it.

Then the Saffron concentrate is added in the required ratio of 1:9 i.e. in the ratio of 1 part saffron concentrate & 9 parts admix of ENA & DMW. So to becomes 10 volume of saffron liqueur.

Then food grade sugar of about 15% is added & mixed properly until it is completely dissolved in it.

Then the saffron cream liqueur is ready to be filtered and filled in opec glass jar or stainless steel jar and stored in cool place below room temperature of about 15%. Saffron cream liqueur is now ready to be bottled in glass bottles and kept in a cool place below room temperature of about 10 to 15 degree.

The invention will now be explained with the help of examples without limiting the scope of the invention.

### EXAMPLE 1

Preparing saffron concentrate by adding saffron 2.5 gm in one liter of ENA (187.5 ML of ENA of 68.0 Over Proof (96% v/v) 812.5 ML of DMW) and stirring the said mixture of ENA and saffron for 24 hours so as extract the essential oil containing aroma, color and flavor and filtering the said mixture of saffron and the ENA to obtain the saffron concentrate. The concentrate is then diluted from 68% OP to 9-45% by adding demineralized water at room temperature. 10% food grade white milk cream is added and properly mixed. About 10% food grade sugar is added and mixed till sugar is dissolved. Adding about 2.5% food grade flavoring agent and mixing it thoroughly and filtering to get saffron cream liqueur.

It will readily be appreciated by those skilled in the art that the present invention is not limited to the specific embodiments herein shown. Thus variations may be made within the scope and spirit of the accompanying claims without sacrificing the principal advantages of the invention.

1-6. (canceled)

7. Saffron cream liqueur obtained by the process comprising the following steps:
adding 1-5 g of saffron to one liter of Extra Neutral Alcohol (ENA)/Silent Spirit of 68% Over Proof (OP), i.e., 96% v/v;
intermittently stirring the mixture of ENA/Silent Spirit and saffron for 18-36 hours,
extracting an essential oil containing aroma, color and flavor,
filtering the mixture of saffron and ENA/Silent Spirit to obtain saffron concentrate,
diluting the the saffron concentrate from 68% OP to 9-45% OP by adding demineralized water at room temperature,
adding about 5-15% food grade white milk cream and properly mixing it,
adding about 5-20% food grade sugar and mixing until the sugar is dissolved,
adding about 1-5% food grade flavoring agent and mixing it thoroughly and filtering to get saffron cream liqueur.

8. The saffron cream liqueur of claim 7 wherein a saffron concentrate of 9% is obtained by mixing 93.75 ml of the mixture of saffron and ENA/Silent Spirit with 906.25 ml of demineralized water.

9. The saffron cream liqueur of claim 7 wherein the process for preparation of the saffron cream liqueur is the cold process.

10. The saffron cream liqueur of claim 7 wherein the saffron cream liqueur is stored at 15° C. in clean jar made of glass or stainless steel.

11. The saffron cream liqueur of claim 7 wherein the flavoring agent/s are natural.

12. A process comprising the following steps:
adding 1-5 g of saffron to one liter of ENA/Silent Spirit of 68% OP, i.e., 96% v/v;
intermittently stirring the mixture of ENA/Silent Spirit and saffron for 18-36 hours,
extracting an essential oil containing aroma, color and flavor,
filtering the mixture of saffron and ENA/Silent Spirit to obtain saffron concentrate,
diluting the saffron concentrate from 68% OP to 9-45% OP by adding demineralized water at room temperature,
adding 5-15% food grade white milk cream and properly mixing it,
adding 5-20% food grade sugar and mixing until the sugar is dissolved,
adding 1-5% food grade flavoring agent and mixing it thoroughly and filtering to get saffron cream liqueur.

13. The process of claim 12 wherein a saffron concentrate of 9% is obtained by mixing 93.75 ml of the mixture of saffron and ENA/Silent Spirit with 906.25 ml of Demineralized Water.

14. The process of claim 12 wherein the process for preparation of the saffron cream liqueur is the cold process.

15. The process of claim 12 wherein saffron cream liqueur is stored at 15° C. in a clean jar made of glass or stainless steel.

16. The process of claim 12 wherein the flavoring agent/s are natural flavouring agents.
